(19) United States
(12) Patent Application Publication
(10) Pub. No.: US 2026/0265073 A1
(43) Pub. Date: Sep. 10, 2026

(54) METHOD FOR PREPARING SYNTHETIC HUNTITE, AND POLYURETHANE FIBER USING SAME

(71) Applicant: SUKGYUNG AT CO., LTD., Ansan-si, Gyeonggi-do (KR)

(72) Inventors: Young Chul YOU, Ansan-si, Gyeonggi-do (KR); O Sung KWON, Gunpo-si, Gyeonggi-do (KR); Sang Gon KIM, Seoul (KR); Hyeon Seok CHOI, Ansan-si, Gyeonggi-do (KR); Hyung Jun LIM, Anyang-si, Gyeonggi-do (KR)

(73) Assignee: SUKGYUNG AT CO., LTD., Ansan-si, Gyeonggi-do (KR)

(21) Appl. No.: 18/993,450

(22) PCT Filed: Feb. 8, 2023
(86) PCT No.: PCT/KR2023/001815

§ 371 Date: Jan. 10, 2025

(30) Foreign Application Priority Data
Jul. 11, 2022 (KR) 10-2022-0085076

(51) Int. Cl. C01F 11/18; C08K 3/26

(52) U.S. Cl. CPC C01F 11/18; C08K 3/26; C01P 2002/70; C01P 2004/62; C01P 2006/60; C01P 2006/80; C08K 2003/267

(57) ABSTRACT

The present invention relates to a huntite mineral having a structural formula of Mg₃Ca(CO₃)₄, and provides a method for preparing synthetic huntite microparticles having a whiteness of 80% or higher, a purity of 95% or higher and a maximum particle size of 1 μm or less, and a polyurethane fiber comprising huntite microparticles comprising the same, the method comprising the steps of: preparing a cation precursor material containing magnesium ions and calcium ions in a molar ratio of 3:1, and preparing an anion precursor material containing CO₃²⁻ ions; mixing the precursor materials, thereby obtaining a hydrated huntite crystal precipitate; washing the hydrated huntite crystal precipitate; drying the hydrated huntite crystal precipitate having been washed; heat-treating same in order to remove crystallization water from the hydrated huntite crystal precipitate having been dried; crushing the heat-treated huntite crystal; and surface-treating the crushed huntite crystal particles.

### TECHNICAL FIELD

The present invention relates to the preparation of synthetic huntite microparticles and polyurethane fibers using the same.

### BACKGROUND ART

Methods for obtaining huntite with a maximum particle size (D₁₀₀) of 2 μm or less from natural huntite mineral mainly include mineral quarrying process-coarse crushing process-fine crushing process, using various crushers that use a large amount of energy, such as jaw crushers, pin mills, sand mills, and attrition mills. Additionally, it is difficult to obtain pure huntite microparticles due to the introduction of impurities, such as the introduction of crushing media, that occurs whenever performing each crushing process. Moreover, in the case of natural huntite particles obtained through a mechanical crushing process, the color of the particles varies significantly between lots according to the color of the huntite ore depending on the origin of production. Furthermore, in Prior Art Patent 1, it is not easy to obtain high quality huntite due to introduction of impurities during the crushing process as well as high energy consumption (e.g., the need for heat-treatment at high temperature of 400° C. to 450° C.), and for these reasons, and thus there is a high industrial demand for synthetic huntite with a high maximum particle size (D₁₀₀) of 2 μm or less, which has high whiteness and purity.

### Patent Document

Korean Patent No. 10-0870533 (Spandex fibers containing a mineral mixture of huntite-hydromagnesite)
Korean Patent No. 10-1130510 (Spandex fibers with excellent anti-chlorine and preparation method thereof)

### DISCLOSURE OF THE INVENTION

### Technical Problem

An object of the present invention is to prepare synthetic huntite particles with higher whiteness, higher purity, and a maximum particle size of 1 μm or less than before in large quantities at a low cost.

Another object of the present invention is to provide a polyurethane (spandex) fiber containing the synthetic huntite microparticles

### Technical Solution

As a result of continuing research for several years to prepare huntite that meets the needs of the industry, the researchers have succeeded in synthesizing “synthetic huntite with high whiteness and purity and a maximum particle size (D₁₀₀) of less than 1 micrometer”, thereby solving the issues relating to whiteness, purity, and particle size caused by the existing natural huntite mineral.

The present invention provides a method for preparing synthetic huntite microparticles with a whiteness of 80% or more, a purity of 95% or more, and a maximum particle size of 1 μm or less,
which includes: preparing a cationic precursor raw material including magnesium ions and calcium ions in a 3:1 molar ratio, and preparing an anionic precursor raw material including CO₃²⁻ ions;
mixing the precursor raw materials to obtain a hydrated huntite crystal precipitate;
washing the hydrated huntite crystal precipitate;
drying the washed hydrated huntite crystal precipitate;
heat-treating the dried hydrated huntite crystal precipitate to remove crystal water therein;
crushing the heat-treated huntite crystals; and
surface-treating the crushed huntite crystal particles.

Additionally, the raw materials for magnesium ions are characterized in that they are dolomite, magnesite, magnesium oxide, magnesium chloride, magnesium nitrate, magnesium silicate, magnesium hydroxide, and hydromagnesite, and the raw materials for calcium ions are dolomite, calcium carbonate, calcium hydroxide, calcium oxide, and calcium chloride, and the raw materials of CO₃²⁻ anions are characterized in that they are sodium carbonate, sodium bicarbonate, ammonium carbonate, ammonium bicarbonate, potassium carbonate, potassium bicarbonate, and carbonate ion water obtained by hydrating carbon dioxide gas.

Meanwhile, the mixed solution is characterized in that it has a pH of 9 to 11.

Additionally, the adsorbed water of the synthetic huntite obtained through washing the synthetic huntite precipitate and drying at 100° C. to 120° C. is characterized by having a concentration of 0.5% or less.

Additionally, the crystal water of the synthetic huntite obtained by heat treating the dried synthetic huntite at 250° C. to 300° C. is characterized by having a concentration of 1% or less.

Additionally, upon XRF analysis of the synthetic huntite after heat-treatment, the synthetic huntite is characterized by having a MgO content of 32 wt % to 36 wt % and a CaO content of 14 wt % to 18 wt %.

Meanwhile, polyurethane fibers are characterized in that they are prepared using huntite microparticles synthesized according to the above-described preparation method.

### Advantageous Effects

According to the present invention, synthetic huntite particles with higher whiteness and higher purity compared to the conventional ones and with a maximum particle size of 1 μm or less can be prepared in large quantities at a low cost,

Another object of the present invention is to provide polyurethane (spandex) fibers including the synthetic huntite microparticles.

### BRIEF DESCRIPTION OF THE DRAWINGS

FIG. 1 shows a flow chart of the synthetic huntite synthesis process of the present invention.

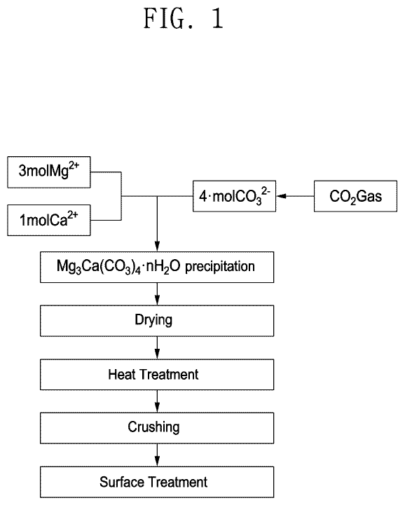

FIG. 2 shows an electronic image and particle size distribution data of synthetic huntite that has undergone washing, drying, and heat-treatment processes.

FIG. 3 shows an image illustrating the changes in contact angle of huntite crystal particles relative to water before and after surface treatment.

### MODE FOR CARRYING OUT THE INVENTION

Dolomite particles with an average particle size of 1-3 mm were obtained from domestic dolomite (CaMg(CO₃)₂) mines and dissolved in 10 wt % nitric acid to be converted into a solution. Then, 2 mol magnesium nitrate was added to this solution to prepare a mixed solution with the ion concentration of the entire solution of 3 mol Mg²⁺ and 1 mol Ca²⁺ was increase, and 4 mol CO₃²⁻ ions corresponding to the mixed cation solution were added to obtain a precipitate. The thus-obtained precipitate is washed using ion-exchanged water and dried, the adsorbed water and crystal water are removed at a temperature between 200° C. and 250° C., and the precipitate is reduced to microparticles using a jet mill, etc., and then surface-treated with a fatty acid or titanium coupling agent. As a result, the resulting product can be ultimately applied as a raw material used in the preparation of polyurethane fiber.

In the preparation of synthetic huntite, which can replace huntite-hydromagnesite, a natural mineral used for adsorption of chloride ions in polyurethane fibers, the most important thing is the ratio of magnesium ions, calcium ions, and carbonate ions. According to the huntite structural formula (Mg₃Ca(CO₃)₄), [Mg]:[Ca]:[CO₃]=3:1:4. In order to achieve this ratio, above all, each raw material with high purity must be used and accurate synthesis conditions must be satisfied so that the co-precipitation reaction can occur well.

The present inventors conducted experiments while closely monitoring this aspect, and accordingly, the method for synthesizing synthetic huntite particles with a maximum particle size of 1 μm or less, which have good whiteness, high purity, and excellent chlorine ion adsorption capacity, and using them for the preparation of polyurethane fibers will be described in more detail. However, the present invention is not limited to what is mentioned in this detailed description.

As the magnesium source to be used as a raw material in the present invention, it is desirable to use dolomite, magnesite, magnesium oxide, magnesium chloride, magnesium nitrate, magnesium silicate, magnesium hydroxide, and hydromagnesite, and as the calcium ion source, it is desirable to use dolomite, calcium carbonate, calcium hydroxide, calcium oxide, calcium chloride, calcium nitrate, etc. In particular, any compound raw material that can be made into a transparent aqueous solution using inorganic acids such as hydrochloric acid or nitric acid can be used, but is not limited to any specific raw material. Additionally, the carbonate ion source that can supply carbonate ions may be any source that can supply sodium carbonate, sodium bicarbonate, ammonium carbonate, ammonium bicarbonate, potassium carbonate, potassium bicarbonate, and carbonate ion water obtained by hydrating carbon dioxide gas, but is not limited to any specific raw material.

### 1. Synthesis of Huntite Crystals

After preparing a mixed aqueous solution including 3 mol of a magnesium raw material and 1 mol of a calcium raw material, and an aqueous solution of 4 mol carbonate anion (CO₃²⁻) corresponding thereto, and while adding a certain amount of pure water in advance to a reactor equipped with a stirrer with stirring, the above-identified two aqueous solutions were introduced into the reactor at a rate of 100 mL/min through a metering pump to synthesize huntite hydrate (Mg₃Ca(CO₃)₄·nH₂O). The mixed solution is characterized by having a pH of 9 to 11.

Unnecessary ion species in the thus-synthesized huntite hydrate (Mg₃Ca(CO₃)₄·nH₂O) were removed through a washing process and the washed huntite hydrate (Mg₃Ca(CO₃)₄·nH₂O) can be obtained. Additionally, dried huntite hydrate (Mg₃Ca(CO₃)₄·nH₂O) could be obtained by drying the washed huntite hydrate at 100° C. to 120° C. to remove the water adsorbed on the surface of the particles, and in particular, the concentration of the adsorbed water was 0.5%, Then, in order to remove crystal water in huntite hydrate (Mg₃Ca(CO₃)₄·nH₂O), the resultant was subjected to a heat-treatment process at 250° C. to 300° C., and finally huntite hydrate (Mg₃Ca(CO₃)₄·nH₂O), in which the crystal water was removed, was obtained. In particular, the concentration of crystal water was 1% or less.

Then, the obtained huntite crystals (Mg₃Ca(CO₃)₄) were identified through X-ray diffraction analysis (XRD) and were found to be identical to the crystal structure of natural huntite (Mg₃Ca(CO₃)₄). The XRF analysis revealed that the MgO content was 32 wt % to 36 wt % and the CaO content was 14 wt % to 18 wt %,

### 2. Crushing Process

The thus-synthesized huntite crystals were aggregates, and huntite crystals without aggregates could be obtained through a crushing process using a jet mill, etc., and the maximum particle size (D₁₀₀) of the particles of the huntite crystals obtained through the crushing process as such was 1 μm or less. The analysis device used at this time was a laser diffraction particle size analyzer.

### 3. Surface Treatment

In order to hydrophobize the surface of the crushed huntite crystal particles, fatty acids, titanium capping agents, etc. may be used. Among the surface treatment agents used herein, as C₈₋₂₆ fatty acids, saturated fatty acids (e.g., caprylic acid, capric acid, lauric acid, myristic acid, palmitic acid, stearic acid, arachidic acid, behenic acid, lignoceric acid, cerotic acid, etc.), and unsaturated fatty acids (e.g., myristoleic acid, palmitoleic acid, sapienic acid, oleic acid, elaidic acid, vaccenic acid, linoleic acid, etc.) may be used, and they may be used in combination. Additionally, as compounds that to be used as surface treatment agents, titanium coupling agents, which have an excellent reaction with carbonates, such as monoalkoxy titanatesoxyacetate chelate titanates, A, B ethylene chelates, quat titanates, etc. may be used.

Hereinafter, the present invention will be described in more detail through the following examples. However, the present invention is not limited to these examples.

### Example 1

184.3 g of dolomite particles (a product of Sambo Mining) with the chemical formula [CaMg(CO₃)₂] and particle size of 1-2 mm were slowly dissolved using a 2 N nitric acid solution without undergoing an additional crushing process, a small amount of insoluble impurities (e.g., Si, etc.,) were removed through a filtration process, 500 g of the primary reaction solution was prepared in a 2-L Erlenmeyer flask, and then 296.62 g of magnesium nitrate salt (Mg(NO₃)₂) was added to the primary reaction solution and dissolved to thereby obtain raw materials for a secondary reaction, in which the total final volume of the aqueous solution was adjusted to 1,000 mL.

Additionally, raw materials for a secondary reaction could be obtained by weighing 423.93 g of sodium carbonate in a separate 2-L Erlenmeyer flask container, adding pure water to the container, and appropriately shaking the mixture while adjusting the total volume of the aqueous solution to 1,000 mL.

Next, 1,000 mL of pure water was added in advance into a separate 5-L capacity 4-necked round flask, which was installed with a stirrer, and slowly stirred, and a metering pump was installed in the solution including Mg and Ca ions to be quantitatively introduced into the 5-L round flask; additionally, a solution including CO₃ ions was also installed in the same manner.

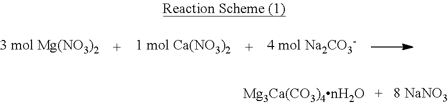

As can be seen in Reaction Scheme (1) above, this reaction is an irreversible reaction, and thus it was possible to easily synthesize huntite crystals including crystal water. Through additional drying, heat-treatment, and crushing processes, the synthetic huntite crystals having an average particle size of 0.33 μm and a maximum particle size of 0.95 μm could be obtained.

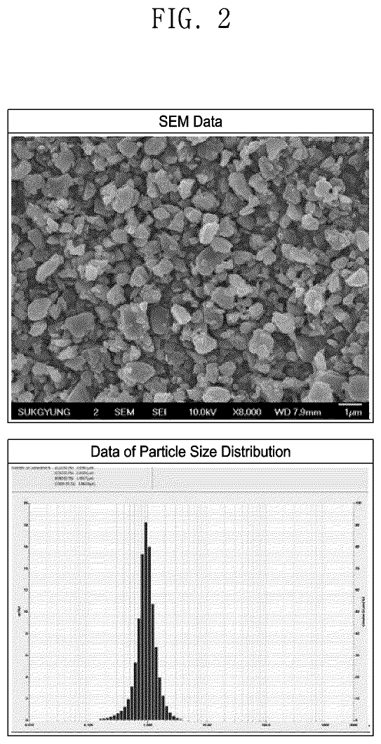

The electronic image and particle size distribution data of the synthetic huntite subjected to the washing, drying, and heat-treatment processes are as shown in FIG. 2.

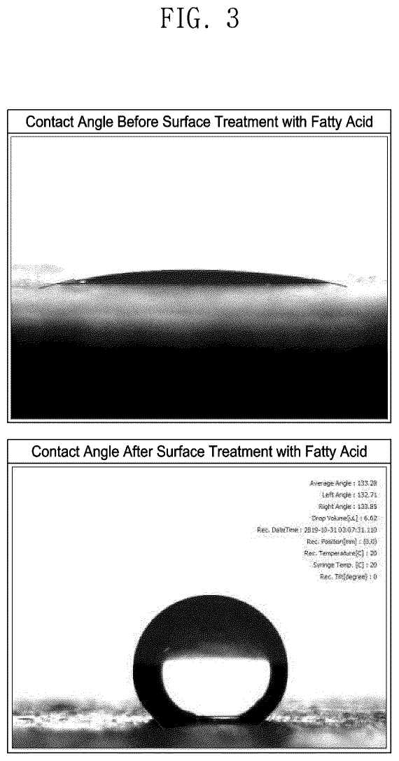

Fatty acids were used to change the surface of huntite particles to have hydrophobicity. That is, 300 g of a solution in which 50 g of stearic acid was previously dissolved was prepared, 1 kg of synthetic huntite crystal particles were added into a Henschel mixer equipped with a heating device with an internal volume of 3 L, stirred slowly at a stirring speed of 200 rpm, and the previously-prepared fatty acid solution was sprayed into the Henschel mixer using a spray gun. Then, the heating device in the Henschel mixer was operated to maintain the temperature at 90° C. for 1 hour to prepare dried hunterite crystals. The contact angle of the thus-obtained huntite crystal particles relative to water was 133.28°. The changes in contact angle before and after surface treatment are shown in FIG. 3.

### Example 2

The experiment was performed in the same manner as in Example 1 except that a 2 N hydrochloric acid solution was used instead of a 2 N nitric acid solution. Through this series of processes, synthetic huntite crystals with an average particle size of 0.25 μm and a maximum particle size of 0.92 μm were obtained. Additionally, the surface of the huntite crystal particles was treated in the same manner as in Example 1, In particular, the contact angle of the obtained huntite crystal particles relative to water was 120°,

### Example 3

Monoalkoxy titanates were used to treat the surface of the synthetic huntite crystal particles obtained in Example 1. That is, 50 g of monoalkoxy titanates were diluted with ethyl alcohol to adjust the total volume to 300 g, and 1 kg of synthetic huntite crystal particles were added into a Henschel mixer equipped with a heating device with an internal volume of 3 L, and the mixture was stirred slowly at a stirring speed of 200 rpm. While stirring, a monoalkoxy titanate-ethyl alcohol solution, which was prepared in advance, was sprayed into the Henschel mixer using a spray gun. Then, the heating device in the Henschel mixer was operated to maintain the temperature at 90° C. for 1 hour to prepare dried hunterite crystals. In particular, the contact angle of the thus-obtained huntite crystal particles relative to water was 130°.

1. A method for preparing synthetic huntite microparticles with a whiteness of 80% or more, a purity of 95% or more, and a maximum particle size of 1 μm or less, comprising:
preparing a cationic precursor raw material comprising magnesium ions and calcium ions in a 3:1 molar ratio, and preparing an anionic precursor raw material comprising CO₃²⁻ ions;
mixing the precursor raw materials to obtain a hydrated huntite crystal precipitate;
washing the hydrated huntite crystal precipitate;
drying the washed hydrated huntite crystal precipitate;
heat-treating the dried hydrated huntite crystal precipitate to remove crystal water therein;
crushing the heat-treated huntite crystals; and
surface-treating the crushed huntite crystal particles.

2. The method of claim 1, wherein the raw materials of magnesium ions are dolomite, magnesite, magnesium oxide, magnesium chloride, magnesium nitrate, magnesium silicate, magnesium hydroxide, and hydromagnesite.

3. The method of claim 1, wherein the raw materials of calcium ions are dolomite, calcium carbonate, calcium hydroxide, calcium oxide, calcium chloride, and calcium nitrate.

4. The method of claim 1, wherein the raw materials of CO₃²⁻ anions are sodium carbonate, sodium bicarbonate, ammonium carbonate, ammonium bicarbonate, potassium carbonate, potassium bicarbonate, and carbonate ion water obtained by hydrating carbon dioxide gas.

5. The method of claim 1, wherein the mixed solution has a pH of 9 to 11.

6. The method of claim 1, wherein the concentration of adsorbed water of the synthetic huntite obtained through washing the synthetic huntite precipitate and drying at 100° C. to 120° C. is 0.5% or less.

7. The method of claim 1, wherein the concentration of crystal water of the synthetic huntite obtained by heat-treating the dried synthetic huntite at 250° C. to 300° C. is 1% or less.

8. The method of claim 1, wherein when the synthetic huntite is analyzed by XRF after heat-treatment, the MgO content is 32 wt % to 36 wt % and the CaO content is 14 wt % to 18 wt %.

9. A polyurethane fiber comprising huntite microparticles prepared according to claim 1.

10. A polyurethane fiber comprising huntite microparticles prepared according to claim 2.

11. A polyurethane fiber comprising huntite microparticles prepared according to claim 3.

12. A polyurethane fiber comprising huntite microparticles prepared according to claim 4.

13. A polyurethane fiber comprising huntite microparticles prepared according to claim 5.

14. A polyurethane fiber comprising huntite microparticles prepared according to claim 6.

15. A polyurethane fiber comprising huntite microparticles prepared according to claim 7.

16. A polyurethane fiber comprising huntite microparticles prepared according to claim 8.
